(19) United States
(12) Patent Application Publication
(10) Pub. No.: US 2005/0029250 A1
(43) Pub. Date: Feb. 10, 2005

(54) Heater controller for gas sensor ensuring stability of temperature control

(75) Inventors: Mitsunobu Niwa, Kariya-shi (JP); Eiichi Kurokawa, Okazaki-shi (JP); Satoshi Hada, Inazawa-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pret (JP)

(21) Appl. No.: 10/913,382

(22) Filed: Aug. 9, 2004

(30) Foreign Application Priority Data
Aug. 7, 2003 (JP) 2003-288895

(51) Int. Cl. H05B 1/02

(52) U.S. Cl. 219/494; 204/228.6

(57) ABSTRACT

A heater controller designed to control the thermal energy produced by a heater under feedback control for heating a body of a gas sensor up to a desired activated temperature. The heater controller works to determine a feedback gain such a proportional or an integral gain as a function of a deviation of the temperature of the gas sensor from a target one and change it based on a condition in which the temperature of the gas sensor is changing from the target value. This ensures the stability of control of the temperature of the gas sensor regardless of a disturbance such as a change in ambient temperature and keeps the accuracy of gas measurement at a higher level.

### BACKGROUND OF THE INVENTION

1. Technical Field of the Invention

The present invention relates generally to a heater controller designed to control the thermal energy produced by a heater for heating a body of a gas sensor up to a desired activated temperature, and more particularly such a heater controller which ensures the stability of control of the temperature of a gas sensor regardless of a control disturbance such as a change in temperature or flow rate of a gas to be measured by the gas sensor.

2. Background Art

Some of modern automotive vehicles equipped with an internal combustion engine have a gas sensor installed in an exhaust system of the engine which measures the concentration of a specified component of exhaust emissions from the engine for use in controlling the exhaust emissions.

Typical gas sensors used in such a system have a solid electrolyte body made of zirconia which forms an electrochemical cell sensitive to a target gas component. Keeping the accuracy of gas measuring requires keeping the temperature of the body of the gas sensor at a activation temperature. To this end, a heater is usually embedded in the body of the gas sensor which is controlled by a heater power controller. The heater power controller is designed to measure the internal resistance of the cell of the gas sensor and regulate a supply of electric power to the heater under feedback control to bring the internal resistance into agreement with a target one. For example, U.S. Pat. No. 6,453,742 B1 to Kawase et al., assigned to the same assignee as that of this application, teaches a conventional heater controller of the type, as described above.

Usually, the above type of gas sensor is sensitive to a disturbance such as a change in ambient temperature and thus undergoes a change in temperature of the body thereof. In a case where the gas sensor is employed in an automotive internal combustion engine, the gas sensor is subjected to a change in temperature thereof arising from a change in temperature or flow rate of exhaust gas from the engine. Such a temperature change will cause an activated state of the gas sensor to change, which leads to a greater concern about reduction in accuracy of measuring the concentration of a specified component of the exhaust gas. Particularly, in a case where the gas sensor is designed to measure the concentration of NOx contained in the exhaust gas of the engine, a change in temperature of the gas sensor impinges upon the measurement accuracy greatly because a current outputted from the gas sensor as a function of the concentration of NOx is usually of the order of nA to μA.

### SUMMARY OF THE INVENTION

It is therefore a principal object of the present invention to avoid the disadvantages of the prior art.

It is another object of the present invention to provide a heater controller designed to ensure the stability of control of temperature of a gas sensor regardless of a disturbance thereto, thereby keeping the accuracy of measuring the concentration of gas at a high level.

According to one aspect of the invention, there is provided a heater controller which works to control an operation of a heater installed in a gas sensor equipped with a solid electrolyte body for heating the gas sensor up to a desired activation temperature. The heater controller comprises: (a) a temperature determining circuit working to determine a temperature of the gas sensor; and (b) a heater power controlling circuit working to control a supply of electric power to the heater under feedback control. The heater power controlling circuit determines a feedback gain used in the feedback control as a function of a deviation of the temperature of the gas sensor as determined by the temperature determining circuit from a target value. The heater power controlling circuit changes the feedback gain based on a condition in which the temperature of the gas sensor is changing from the target value. The feedback control is implemented by, for example, a proportional-plus-integral control. The feedback gain is at least one of proportional and integral gains. The temperature of the gas sensor may be determined by measuring an internal resistance value of the gas sensor.

Usually, when an ambient temperature changes, it will be a disturbance to control the temperature of the body of the gas sensor, thus resulting in reduction in measurement accuracy of the gas sensor. In order to avoid this problem, the heater power controlling circuit works to determine the feedback gain as a function of the deviation of the temperature of the gas sensor from the target value and change the feedback gain based on the condition in which the temperature of the gas sensor is changing from the target value. When the temperature of the gas sensor is near the target value, decreasing the feedback gain enables the temperature of the gas sensor to be controlled with a fine resolution. When the temperature of the gas senor is far from the target value, increasing the feedback gain results in increased convergence of the temperature on the target value. This ensures the stability of control of the temperature of the gas sensor, which keeps the measurement accuracy of the gas sensor at a high level.

In the preferred mode of the invention, the heater power controlling circuit increases the feedback gain when the deviation of the temperature of the gas sensor from the target value is greater than a given threshold value.

The heater power controlling circuit changes the feedback gain when the temperature of the gas sensor is changing away from the target value, and the deviation of the temperature of the gas sensor from the target value exceeds a first threshold value and when the temperature of the gas sensor is changing toward the target value, and the deviation of the temperature of the gas sensor from the target value drops below a second threshold value smaller than the first threshold value. Specifically, a threshold value used for comparison with the deviation of the temperature of the gas sensor has a hysteresis, thereby minimizing unwanted changing of the feedback gain to avoid control hunting.

The heater power controlling circuit may increase the feedback gain continuously with an increase in the deviation of the temperature of the gas sensor from the target value. This avoid a sudden change in the control of the temperature of the gas sensor occurring upon a stepwise change in the feedback gain.

The heater power controlling circuit may increase the feedback gain when the temperature of the gas sensor is changing away from the target value, and a rate of change in the temperature of the gas sensor is greater than a given threshold value. Specifically, when the rate at which the temperature of the gas sensor changes away from the target value is great, it is possible that the temperature of the gas sensor will be far from the target value. Even in such an event, quick convergence of the temperature on the target value is achieved.

The heater power controlling circuit increases the feedback gain when the temperature of the gas sensor is approaching the target value, and the rate of change in the temperature of the gas sensor is smaller than a given threshold value. Specifically, when the rate at which the temperature of the gas sensor approaches the target value is small, it is possible that the temperature of the gas sensor will take much time to reach the target value. In such an event, the increasing of the feedback gain shortens the time required for the temperature of the gas sensor to reach the target value.

The gas sensor may be installed in an exhaust system of an internal combustion engine to measure an exhaust gas emitted from the engine. In this case, the heater power controlling circuit works to calculate a change in the temperature of the gas sensor as a function of an operating condition of the engine and change the feedback gain based on the calculated change in the temperature of the gas sensor.

The feedback gain may be one of a proportional gain and an integral gain determined by the deviation of the temperature of the gas sensor from the target.

The heater power control circuit may further use a derivative gain in the feedback control to control the supply of electric power to the heater when the deviation of the temperature of the gas sensor from the target value is greater than a given threshold value.

The gas sensor may include a first cell, a second cell, and a gas chamber. The first cell is formed by a pair of electrodes affixed to the solid electrolyte body. The second cell is formed by a pair of electrodes affixed to the solid electrolyte body. Upon application of voltage across the electrodes, the first cell works to adjust an amount of oxygen contained in a gas entering the gas chamber to a given lower level. The second cell works to measure a concentration of a specified component of the gas after having passed the first cell.

According to the second aspect of the invention, there is provided a heater controller working to control an operation of a heater installed in a gas sensor equipped with a solid electrolyte body for heating the gas sensor up to a desired activation temperature. The heater controller comprises: (a) a temperature determining circuit working to determine a temperature of the gas sensor; and (b) a heater power controlling circuit working to control a supply of electric power to the heater under feedback control. The heater power controlling circuit determines a feedback gain used in the feedback control as a function of a deviation of the temperature of the gas sensor as determined by the temperature determining circuit from a target value. The heater power controlling circuit sets the feedback gain to a constant value when the temperature of the gas sensor lies within a target range defined across the target value, while the heater power controlling circuit sets the feedback gain to a value greater than the constant value when the temperature of the gas sensor lies out of the target range or when the temperature of the gas sensor is changing at a rate which is expected to cause the temperature of the gas sensor to move out of the target range.

The above heater control serves to improve convergence of the temperature of the gas sensor on the target value when the temperature of the gas sensor lies out of the target range or when the temperature of the gas sensor is changing at the rate which is expected to cause the temperature of the gas sensor to move out of the target range. When the temperature of the gas sensor is lies within the target rage, the feedback gain is kept at the constant value, thereby maintaining the desired resolution in controlling the temperature of the gas sensor.

In the preferred mode of the invention, the heater power controlling circuit may increase the feedback gain continuously as the temperature of the gas sensor changes away from the target range.

The heater power controlling circuit may return the feedback gain to the constant value when the temperature of the gas sensor is changing toward the target range again after the temperature of the gas sensor has fallen in the target range.

The feedback gain may be one of a proportional gain and an integral gain determined by the deviation of the temperature of the gas sensor from the target.

The heater power control circuit may further use a derivative gain in the feedback control to control the supply of electric power to the heater when the deviation of the temperature of the gas sensor from the target value is greater than a given threshold value.

The gas sensor includes a first cell, a second cell, and a gas chamber. The first cell is formed by a pair of electrodes affixed to the solid electrolyte body. The second cell is formed by a pair of electrodes affixed to the solid electrolyte body. Upon application of voltage across the electrodes, the first cell works to adjust an amount of oxygen contained in a gas entering the gas chamber to a given lower level. The second cell works to measure a concentration of a specified component of the gas after having passed the first cell.

According to the third aspect of the invention, there is provided a heater controller working to control an operation of a heater installed in a gas sensor equipped with a solid electrolyte body for heating the gas sensor up to a desired activation temperature. The heater controller comprises: (a) a temperature determining circuit working to determine a temperature of the gas sensor; and (b) a heater power controlling circuit working to control a supply of electric power to the heater under feedback control. The heater power controlling circuit determines at least one of a proportional gain and an integral gain used in the feedback control as a function of a deviation of the temperature of the gas sensor as determined by the temperature determining circuit from a target value. The heater power controlling circuit further use a derivative gain in the feedback control to control the supply of electric power to the heater when the deviation of the temperature of the gas sensor from the target value is greater than a given threshold value.

Specifically, the user of the derivative gain when the deviation increases serves to control the electric power to the heater so as to minimize a change in the temperature of the gas sensor.

The gas sensor may include a first cell, a second cell, and a gas chamber. The first cell is formed by a pair of electrodes affixed to the solid electrolyte body. The second cell is formed by a pair of electrodes affixed to the solid electrolyte body. Upon application of voltage across the electrodes, the first cell works to adjust an amount of oxygen contained in a gas entering the gas chamber to a given lower level. The second cell works to measure a concentration of a specified component of the gas after having passed the first cell.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit block diagram which shows a gas concentration measuring device according to the invention;

FIG. 2 is a plane view which shows arrangements of electrodes of a monitor and a sensor cell;

FIG. 3 is an illustration which shows heat dissipated from an equivalent model of a gas sensor;

FIG. 4 is a time chart which shows a relation among the amount of electric power supplied to a heater, a heater resistance, and a monitor cell admittance;

FIG. 5(a) shows a relation among a monitor cell admittance, a duty cycle of a heater control signal, and the concentration of NOx when a feedback gain is greater;

FIG. 5(b) shows a relation among a monitor cell admittance, a duty cycle of a heater control signal, and the concentration of NOx when a feedback gain is smaller;

FIG. 6 is a flowchart of a main program executed to measure the concentration of NOx and control a supply of electric power to a heater;

FIG. 7 is a flowchart of a sub-program executed in the main program of FIG. 6 to control the supply of electric power to the heater according to the first embodiment of the invention;

FIG. 8 is a graph which shows a relation between P and I gains used in PI control and a deviation of the temperature of a gas sensor from a target one;

FIG. 9 is a time chart which shows an example in which P and I gains used in PI control are changed as a function of a monitor cell admittance in the first embodiment;

FIG. 10 is a flowchart of a sub-program executed in the main program of FIG. 6 to control the supply of electric power to the heater according to the second embodiment of the invention;

FIGS. 11 and 12 are time charts which show examples in which P and I gains used in PI control are changed as a function of a monitor cell admittance in the second embodiment; and

FIG. 13 is a flowchart of a program to perform PID control which may be employed in either of the first and second embodiments.

### DESCRIPTION OF THE PREFERRED EMBODIMENTS

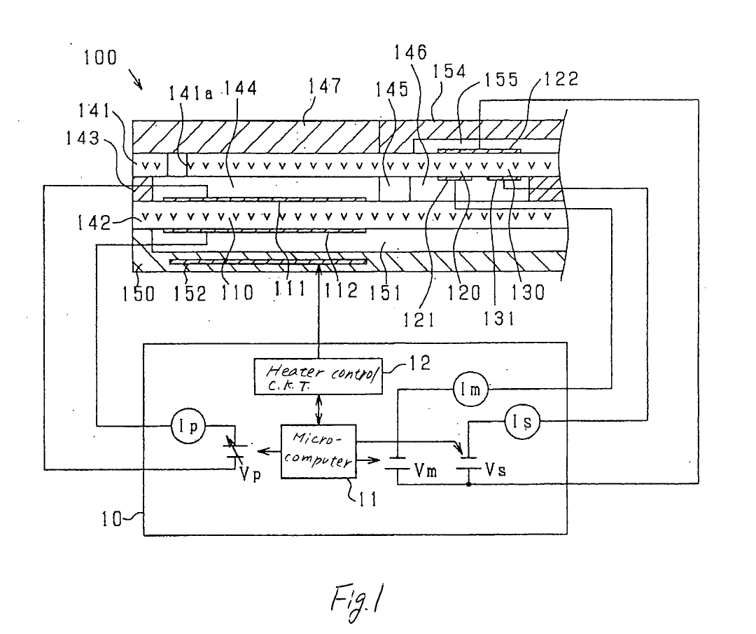

Referring now to the drawings, wherein like numbers refer to like parts in several views, particularly to FIG. 1, there is shown a gas concentration measuring device according to the first embodiment of the invention which consists essentially of a gas sensor 100 and a sensor control circuit implemented by an electronic control unit (ECU) 10.

The gas sensor 100 is installed, for example, in an exhaust pipe of an automotive internal combustion gasoline engine and exposed to exhaust gasses emitted from the engine. The gas sensor 100 is of a limiting current type and works to produce a limiting current as a function of concentration of a specified component contained in the exhaust gasses. The sensor ECU 10 is responsive to the output from the gas sensor 100 to determine the concentration of the specified gas component. In the following discussion, the gas sensor 100 is assumed to measure at least the concentration of nitrogen oxide (NOx).

FIG. 1 illustrates an internal structure of a top portion of the gas sensor 100. The gas sensor 100 is of a three-cell type made up of a pump cell 110, a monitor cell 120, and a sensor cell 130. The gas sensor 100 is, in practice, disposed within a housing (not shown) and installed, for example, in the exhaust pipe of the automotive engine.

The gas sensor 100 is, as clearly shown in FIG. 1, formed by a lamination of a porous diffusion layer 147, oxygen ion-conductive solid electrolyte layers 141 and 142, a spacer 143, and an insulating layer 150. The solid electrolyte layers 141 and 142 are made of zirconia strips, respectively. The spacer 143 is made of an insulating material such as alumina. The solid electrolyte layers 141 and 142 are laid at a given interval therebetween through the spacer 143 to define a first gas chamber 144 and a second gas chamber 146. The solid electrolyte layer 141 has formed therein a gas inlet 141a at which the exhaust gas flowing outside the gas sensor 100 enters the first gas chamber 144. The first gas chamber 144 communicates with the second gas chamber 146 through an orifice 145. The porous diffusion layer 147 is disposed on the solid electrolyte layer 141 to cover the gas inlet 141a in order to have the exhaust gas undergo a given diffusion resistance when entering the first gas chamber 144. An insulating layer 154 is affixed to the solid electrolyte layer 144 next to the porous diffusion layer 147 and defines an air duct 155 leading to the atmosphere.

The insulating layer 150 is affixed to the solid electrolyte layer 142 to define an air duct 151 leading to the atmosphere.

The solid electrolyte layer 142 has formed on opposed surfaces thereof electrodes 111 and 112 which are exposed to the first gas chamber 144 and the air duct 151, respectively, and forms the pump cell 110 together with the electrodes 111 and 112. The electrode 111 exposed to the first gas chamber 144 is made of material which is inactive with respect to NOx, that is, hardly decomposes NOx. Upon application of voltage across the electrodes 111 and 112, the pump cell 110 decomposes or ionizes oxygen (O₂) within the first gas chamber 144 and pumps it to the air duct 151 through the electrode 112 so as to keep the concentration of oxygen remaining within the first gas chamber 144 constant.

The solid electrolyte layer 141 has electrodes 121, 122, and 131 disposed on opposed surfaces thereof. The electrode 122 exposed to the air duct 155 serves as an electrode common to the electrodes 121 and 131. The solid electrolyte layer 141 forms the monitor cell 120 together with the electrodes 121 and 122 and the sensor cell 130 together with the electrode 131 and 122. The monitor cell 120 works to produce an electric current as a function of the concentration of oxygen (O₂) remaining within the second gas chamber 146. The monitor cell 120 may alternatively be designed to produce an electromotive force as a function of the concentration of oxygen within the second gas chamber 146. The sensor cell 130 is responsive to the gas having passed the pump cell 110 to produce an electric current as a function of the concentration of NOx contained in the gas.

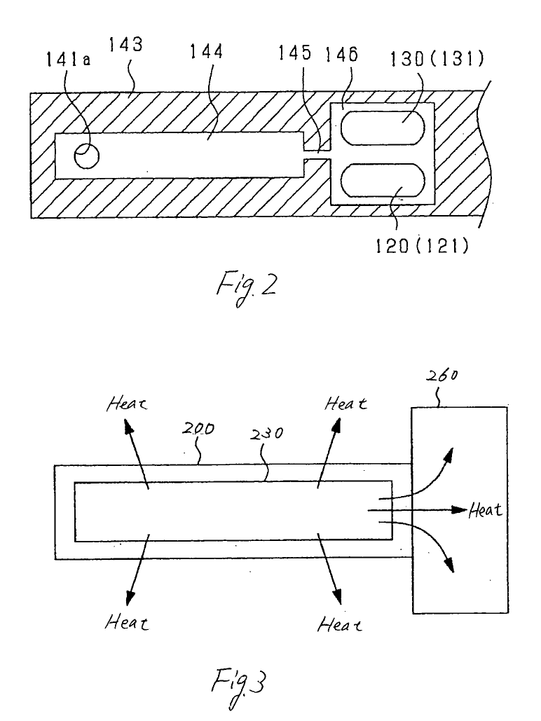

The monitor cell 120 and the sensor cell 130 are arrayed adjacent each other and share the electrode 122 with each other. Specifically, the monitor cell 120 is, as described above, made up of the solid electrolyte layer 141, the electrode 121, and the common electrode 122. The sensor cell 130 is made up of the solid electrolyte layer 141, the electrode 131, and the common electrode 122. The electrode 121 of the monitor cell 120 exposed to the second gas chamber 146 is made of noble metal such as Au—Pt which is inactive with respect to NOx, that is, hardly decomposes NOx. The electrode 131 of the sensor cell 130 exposed to the second gas chamber 146 is made of noble metal such as Pt (Platinum) or Rh (Rhodium) which is active with respect to NOx, that is, serves to decompose or ionize NOx. FIG. 1 shows the electrodes 121 and 131 as being arrayed adjacent each other in a direction of flow of the gas for ease of visibility thereof, but however, they are, as clearly shown in FIG. 2, arrayed parallel to each other at the same position in the direction of flow of the gas.

The insulating layer 150 affixed to a lower surface, as viewed in FIG. 1, of the solid electrolyte layer 142 is made of alumina. The insulating layer 150 has embedded therein a Pt-made patterned conductor which works as a heater 152 for heating the whole of the gas sensor 100 (especially, the solid electrolyte layers 141 and 142) up to a desired activation temperature. The heater 152 is supplied with electric power from, for example, a battery mounted in the automotive vehicle.

The exhaust gas of the engine flowing outside the gas sensor 100, as described above, enters the first gas chamber 144 through the porous diffusion layer 147 and the gas inlet 141a. Application of voltage Vp to the pump cell 110 through the electrodes 111 and 112 causes the oxygen (O₂) contained in the exhaust gas to undergo dissociation or ionization, so that the oxygen (O₂) is pumped out of the first gas chamber 144 to the air duct 151. If the concentration of the oxygen (O₂) is lower than a desired level in the first gas chamber 144, a reverse voltage is applied to the pump cell 110 to pump oxygen molecules into the first gas chamber 144 from the air duct 151 so as to keep the concentration of oxygen (O₂) within the first gas chamber 144 constant. The electrode 111 exposed to the first gas chamber 144 is, as described above, inactive with NOx. The pump cell 110, thus, decomposes O₂ only without decomposing NOx.

After having passed the pump cell 110, the exhaust gas flows into the second gas chamber 146 and reaches the monitor cell 120 and the sensor cell 130. Upon application of voltage Vm across the electrodes 121 and 122, the monitor cell 120 produced an electric current Im as a function of the concentration of oxygen remaining within the second gas chamber 146. Upon application of voltage Vs across the electrodes 131 and 122, the sensor cell 130 works to reduce and decompose NOx contained in the exhaust gas and pump oxygen arising from the decomposition of NOx into the second air duct 155 through the electrode 122, thereby producing an electric current Is as a function of the concentration of NOx in the exhaust gas.

EPO 987 546 A2, assigned to the same assignee as that of this application, teaches control of an operation of this type of gas sensor, disclosure of which is incorporated herein by reference.

The sensor ECU 10 works to control the operation of the gas sensor 100. The sensor ECU 10 uses the outputs from the pump cell 110, the monitor cell 120, and the sensor cell 130 to determine the concentration of O₂ as indicating an air/fuel ratio of mixture supplied to the engine and the concentration of NOx and outputs signals indicative thereof to an engine ECU (not shown). The sensor ECU 10 includes a microcomputer 11 and a heater control circuit 12. The microcomputer 11 works to control the voltages Vp, Vm, and Vs to be applied to the pump cell 110, the monitor cell 120, and the sensor cell 130 and receive the pump cell current Im, the monitor cell current Im, and the sensor cell current Is to determine the concentration of O₂ and NOx contained in the exhaust gas.

The heater control circuit 12 has installed therein a switching element and drives it in an on-off operation to control a supply of power to the heater 152. Specifically, the heater control circuit 12 controls the operation of the heater 152 through the PI control using feedback gains such as proportional (P) and integral (I) gains. The heater control circuit 12 determines the P and I gains as a function of a difference between a resistance value of the gas sensor 100 changing with a change in temperature thereof and a target one and also determines the duty cycle of a heater drive signal to the switching element based on a heater control variable as derived by the I and P gains. The heater 152 heats the gas sensor 100 and keeps the temperature thereof at a constant activation temperature required to measure the concentration of oxygen and NOx correctly.

The resistance value of the gas sensor 100 (will also be referred to as a sensor resistance below) is given by the admittance of the monitor cell 120 (will also be referred to as monitor cell admittance MAdm below), as measured in a voltage sweep method which sweeps the monitor cell-applied voltage Vs to at least one of a positive and a negative voltage side instantaneously (e.g., for several ten to one hundred μsec.) to read a change in the monitor cell-applied voltage Vs and a resultant change in the monitor cell current Im of the monitor cell 120. The monitor cell admittance MAdm is determined by a ratio of the change in the monitor cell current Im to the change in the monitor cell-applied voltage Vs (i.e., the change in the monitor cell current Im/the change in the monitor cell-applied voltage Vs). The sensor resistance may alternatively be given by the impedance which is a reciprocal of the monitor cell admittance MAdm or by measuring the admittance (or impedance) of either of the pump cell 110 and the sensor cell 130.

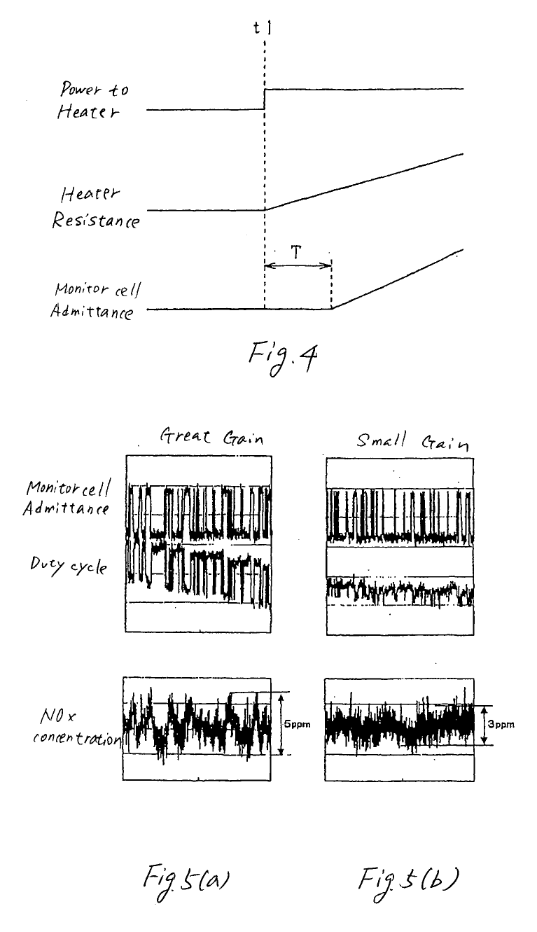

There is concern in the gas sensor 100 that a change in the sensor resistance arising from disturbances such as a change in temperature of the exhaust gas and/or a change in flow rate of the exhaust gas results in reduced accuracy of measuring the concentration of NOx. FIG. 3 illustrates a mechanical equivalent mode of the gas sensor 100 which includes a sensor body 200, a strip-shaped cell 230, and a metal sensor housing 260. The thermal energy in the sensor body 200 is dissipated easily from the surface thereof because the strip-shaped cell 230 occupies most of the volume of the sensor body 200 and also transferred to the metal sensor housing 260 because the housing 260 is joined to an end of the sensor body 200, and the cell 230 extends to near the housing 260. This increases ease of change in temperature of the sensor body 200. As can be seen from FIG. 1, the heater 152 is located far from the monitor cell 120. Thus, in a case where the temperature of the gas sensor 100 is determined using the monitor cell admittance MAdm, a rate of change in temperature of a portion of the body of the gas sensor 100 between the heater 152 and the monitor cell 120 will be great, which contributes to reduction in controllability of the temperature of the gas sensor 100. Referring to FIG. 4, when a supply of electric power to the heater 152 is increased at time t1, the resistance of the heater 152 increases immediately, while the monitor cell admittance MAdm increases after a lapse of time T. This results in a delay in controlling the temperature of the gas sensor 100 when a disturbance such as a change in temperature or flow rate of the exhaust gas occurs, thus leading to a variation in temperature of the body of the gas sensor 100. Usually, the concentration of NOx is required to be measured in a unit of ppm. The sensor current Is is in the order of nA to μA. Therefore, the variation in temperature of the body of the gas sensor 100 may result in decreased accuracy of measuring the concentration of NOx.

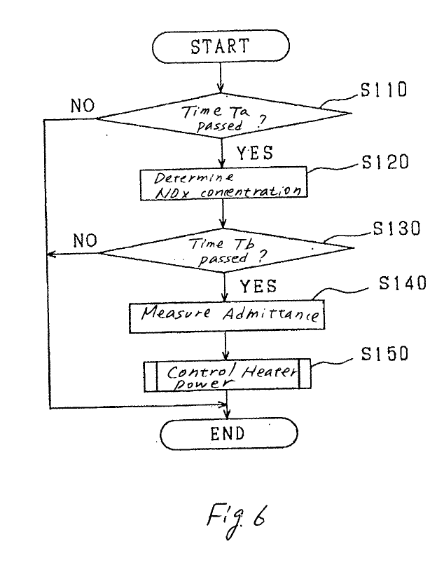

The control of the temperature of the gas sensor requires the feedback gains to be increased to minimize a difference between an actual temperature of the gas sensor 100 and a target one upon occurrence of the disturbance. The increase in the feedback gains, however, results in an undesirable reduction in resolution of controlling the temperature around the target, so that the temperature of the gas sensor 100 varies finely across the target. This becomes impossible to meet the requirement of accuracy of determining the concentration of NOx in the unit of ppm. It is, thus, necessary to minimize the feedback gains near the target temperature of the gas sensor 100 to increase the resolution of controlling the temperature of the gas sensor 100. FIGS. 5(a) and 5(b) represent relations among the monitor cell admittance MAdm, the duty cycle of the heater control signal for the heater 152, and the concentration of NOx when the feedback gains are great and small, respectively. The relations show that the amplitude of a change in the duty cycle of the heater control signal when the feedback gains are great is greater than that when the feedback gains are small, so that a variation in measured value of the concentration of NOx increases when the feedback gains are great. It is found that it is not preferable to increase the feedback gains greatly in order to enhance the accuracy of measuring the concentration of NOx.

In view of the above problem, the sensor ECU is designed to change the feedback gains (i.e., the proportional (P) and integral (I) gains in the PI control of the heater 152) as a function of a difference between the temperature of the gas sensor 100 (i.e., the monitor cell admittance MAdm) as measured and the target one. Specifically, when such a difference is smaller than a given threshold value, the P and I gains are decreased, while it is greater than the threshold value, the P and I gains are increased.

FIG. 6 is a flowchart of logical steps or program executed by the microcomputer 11 of the sensor ECU 10. The program is initiated upon turning on of the microcomputer 11 and executed at given time intervals.

After entering the program, the routine proceeds to step 110 wherein it is determined whether a preselected period of time Ta has passed or not after the concentration of NOx is determined previously. The period of time Ta is a cycle of, for example, 4 msec. during which the concentration of NOx is measured. If a YES answer is obtained in step 110, then the routine proceeds to step 120 wherein the concentration of NOx is determined. This determination is achieved by monitoring the sensor cell current Is and the monitor cell current Im and calculating a difference therebetween (i.e., Is−Im) as indicating the concentration of NOx. This current difference is outputted to the engine ECU (not shown).

The routine proceeds to step 130 wherein it is determined whether a preselected period of time Tb has passed or not after the monitor cell admittance MAdm is determined previously. The period of time Tb is a cycle during which the monitor cell admittance MAdm is measured and which is, for example, one of 128 msec. and 2 sec. selected based on an operating condition of the engine. If a YES answer is obtained in step 130, then the routine proceeds to step 140 wherein the monitor cell admittance MAdm is measured.

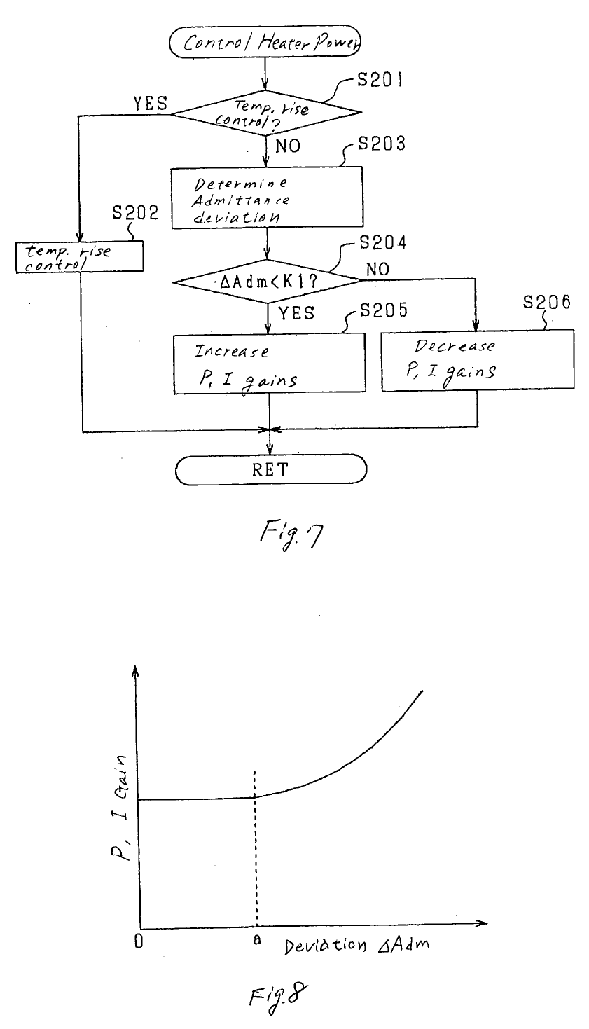

The routine proceeds to step 150 wherein a supply of electric power to the heater 152 is controlled to regulate the amount of heat produced by the heater 152. This control is performed according to a sub-program, as illustrated in FIG. 7.

After entering step 150, the routine proceeds to step 201 wherein it is determined whether a condition in which the temperature of the heater 152 should be increased is met or not. This determination is made by determining whether the monitor cell admittance MAdm is greater than a given threshold value or not or whether a preselected period of time has passed after start-up of the engine or not. For example, when the temperature of the gas sensor 100 is low immediately after the start-up of the engine, the monitor cell admittance MAdm is still below the threshold value, so that a YES answer is obtained in step 201. The routine, thus, proceeds to step 202 wherein the duty cycle of the heater control signal to the heater control circuit 12 is set to 100% to increase the temperature of the heater 152 at a full rate and returns back to the main program of FIG. 6.

When the temperature of the gas sensor 100 has risen, a NO answer is obtained in step 201. The PI control is started to control the supply of electric power to the heater 152. The routine proceeds to step 203 wherein an admittance deviation Δ Adm that is an absolute value of a difference between an actual value of the monitor cell admittance MAdm, as measured under the PI control, and the target value is determined.

The routine proceeds to step 204 wherein it is determined whether the admittance deviation Δ Adm is smaller than a given threshold value K1 or not. The values of the P and I gains are selected based on a result of the determination in step 204. Specifically, when the actual value of the monitor cell admittance MAdm is near the target one, the P and I gains are set to smaller constant values in favor of increasing the accuracy of controlling the temperature of the gas sensor 100. Alternatively, when the actual value of the monitor cell admittance MAdm is far from the target one, the P and I gains are set to greater constant values in favor of convergence of the temperature of the gas sensor 100 on the target one.

Specifically, if a YES answer is obtained in step 204 (i.e., Δ Adm<K1), then the routine proceeds to step 205 wherein the P and I gains are set to the smaller constant values. Alternatively, if a NO answer is obtained (i.e., Δ Adm≧K1), then the routine proceeds to step 206 wherein the P and I gains are set to the greater constant values. In step 206, the P and I gains may alternatively be selected as a function of the admittance deviation Δ Adm. For example, the P and I gains may be increased with an increase in the admittance deviation Δ Adm by look-up using a map, as illustrated in FIG. 8. Note that FIG. 8 does not show that the P and I gains are set to the same value, and the same applies to the following drawings. Specifically, when the admittance deviation Δ Adm is smaller than a given threshold value α, the P and I gains are selected to be a constant value. Alternatively, when it is greater than the threshold value α, the P and I gains are increased gradually as a function of an increase in the admittance deviation Δ Adm.

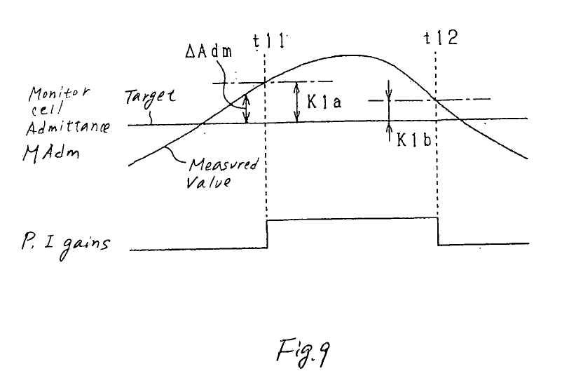

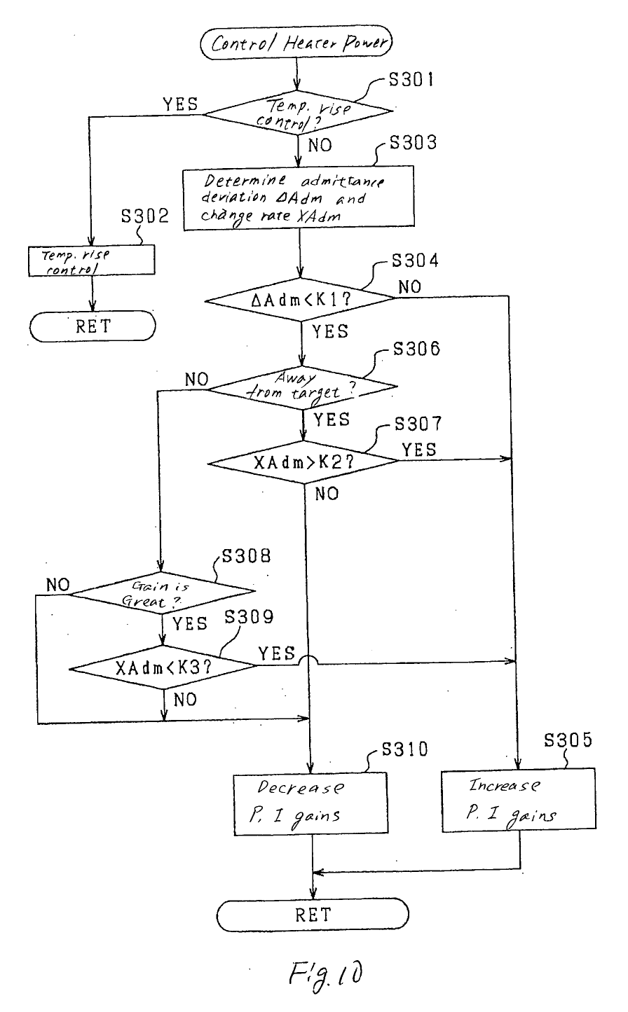

An example of the selection of the P and I gains will be described below in detail with reference to a time chart of FIG. 9. FIG. 9 illustrates for the case where the temperature of the gas sensor 100 (i.e., the monitor cell admittance MAdm) rises due to a change in temperature or flow rate of the exhaust gas of the engine.

The threshold value K1, as used in step 203 of FIG. 7 for comparison with the admittance deviation Δ Adm, may have a hysteresis, as shown in FIG. 9. Specifically, as the threshold value K1, either of two different values K1a and Kb1 is selected depending upon whether the monitor cell admittance MAdm changes toward or away from the target value. When the monitor cell admittance MAdm is changing away from the target value, the value K1a (e.g., +or −0.8% of the target value) is selected as the threshold value K1. Alternatively, when the monitor cell admittance MAdm is approaching the target value, the value K1b (e.g., +or −0.4% of the target value) is selected as the threshold value K1.

In the example of FIG. 9, when the admittance deviation Δ Adm exceeds the threshold value Ka1 at time t11, the P and I gains are set to a value greater than an initially-selected constant value used so far. Subsequently, when the monitor cell admittance MAdm changes toward the target value, and the admittance deviation Δ Adm drops below the threshold value Ka2 at time t12, the P and I gains are returned to the initially-selected constant value. Specifically, between the times t11 and t12, the temperature of the heater 152 is regulated by the PI control using the greater P and I gains.

As apparent from the above discussion, the gas concentration measuring device of this embodiment works to perform a heater control function and select the values of the P and I gains used in the PI control which controls the amount of heat produced by the heater 152 as a function of a change in temperature of the gas-sensor 100 (i.e., the monitor cell admittance MAdm). This ensures the stability of controlling the temperature of the gas sensor 100 regardless of the disturbance and achieves the high accuracy of measurement of the concentration of NOx.

Specifically, the gas concentration measuring device works to change the P and I gains to greater values when the admittance deviation Δ Adm is greater than the threshold value K1 or increase the P and I gains at a given rate with an increase in the admittance deviation Δ Adm after exceeding the threshold value K1. This results in quick convergence of the temperature of the gas sensor 100 on the target value without a sudden change in temperature of the gas sensor 100.

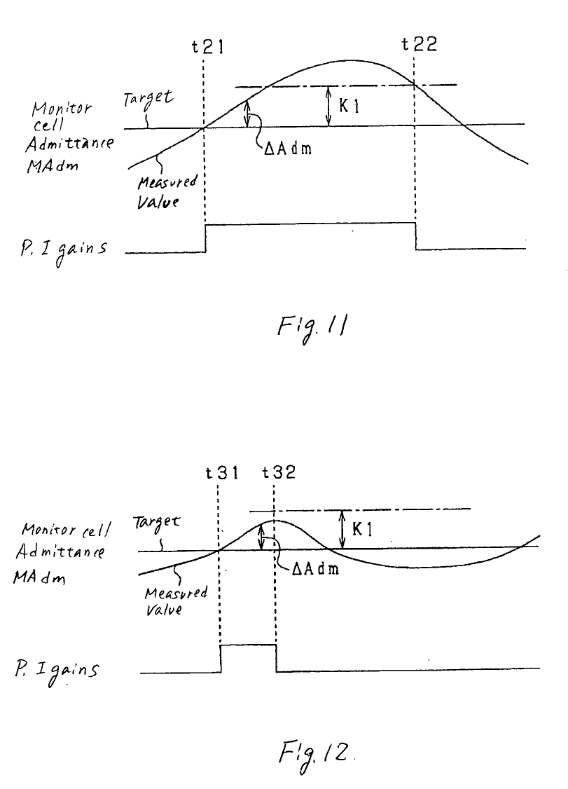

FIG. 10 is a flowchart of a sub-program executed in step 150 of FIG. 6 to control the operation of the heater 152 according to the second embodiment of the invention. The program is to keep the P and I gains at an initially-selected constant value when the monitor cell admittance MAdm lies within a target range defined around the target value and to change the P and I gains to a value greater than the initially-selected constant value when the monitor cell admittance MAdm lies out of the target range or when the P and I gains are changing at a rate which is expected to cause the monitor cell admittance MAdm to change out of the target range.

After entering the program, the routine proceeds to step 301 wherein it is determined whether a condition in which the temperature of the heater 152 should be increased is met or not. If a YES answer is obtained, then the routine proceeds to step 302 wherein the duty cycle of the heater control signal to the heater control circuit 12 is set to 100% to increase the temperature of the heater 152 at a full rate and returns back to the main program of FIG. 6. Steps 301 and 302 are identical in operation with steps 201 and 202 of FIG. 7, respectively, and explanation thereof in detail will be omitted here.

If a NO answer is obtained in step 301, then the routine proceeds to step 303 wherein the admittance deviation Δ Adm that is an absolute value of a difference between an actual value of the monitor cell admittance MAdm, as measured under the PI control, and the target value is determined, and a rate of change in monitor cell admittance MAdm (will also be referred to as an admittance change rate XAdm below) is also determined. The determination of admittance change rate XAdm is achieved by using a blur equation of
XAdmi=XAdmi−1*(n−1)/n+MAdm*1/n
where the affix “i” indicates the value determined in this program cycle, the affix “i−1” indicates the value determined one program cycle earlier, and n is a blur coefficient.

The routine proceeds to step 304 wherein it is determined whether the admittance deviation Δ Adm is smaller than the given threshold value K1 or not. If a NO answer is obtained (i.e., Δ Adm≧K1), then the routine proceeds to step 305 wherein the P and I gains are set to the greater constant values. Steps 304 and 305 are the same as steps 204 and 206, respectively.

Alternatively, if a YES answer is obtained in step 304 (i.e., Δ Adm<K1), then the routine proceeds to step 306 wherein it is determined whether the monitor cell admittance MAdm is changing away from the target value or not. If a YES answer is obtained, then the routine proceeds to step 307 wherein the admittance change rate XAdm is greater than a given threshold value K2 or not. If a YES answer is obtained, then the routine proceeds to step 305. Specifically, if the admittance deviation Δ Adm is smaller than the threshold value K1, but the monitor cell admittance MAdm is changing away from the target value at a greater rate, the routine proceeds to step 305 wherein the P and I gains are changed. Step 305 does not use the map of FIG. 8. For example, the P and I gains are changed to greater constant values or increased at a given rate with an increase in the admittance change rate XAdm.

Alternatively, if a NO answer is obtained in step 307, then the routine proceeds to step 310 wherein the P and I gains are changed to smaller constant values, like step 205 of FIG. 7.

If a NO answer is obtained in step 306 meaning that the monitor cell admittance MAdm is approaching the target value, then the routine proceeds to step 308 wherein it is determined whether the PI control is now being performed using the greater P and I gains or not. The fact that the values of the P and I gains are greater indicates that the admittance deviation Δ Adm has exceeded the threshold value K1, and the PI control is being performed with the P and I gains selected in step 305. If a YES answer is obtained in step 308, then the routine proceeds to step 309 wherein it is determined whether the admittance change rate XAdm is smaller than a given threshold value K3 or not. If a NO answer is obtained meaning that the admittance deviation Δ Adm is determined in step 304 as being smaller than the threshold value K1, but the monitor cell admittance MAdm is approaching the target value with the greater P and I gains, and the admittance change rate XAdm is smaller, then the routine proceeds to step 310 wherein the P and I gains are changed to smaller constant values.

The selection of the P and I gains will be described below in detail with reference to examples, as illustrated in FIGS. 11 and 12.

FIGS. 11 and 12 illustrate for the case where the temperature of the gas sensor 100 (i.e., the monitor cell admittance MAdm) rises due to a change in temperature or flow rate of the exhaust gas of the engine, and each of the P and I gains is switched between two different values: a greater and a smaller value. The threshold value K1, as used in step 304 of FIG. 10 for comparison with the admittance deviation Δ Adm, does not have a hysteresis. Specifically, the same threshold value K1 is used when the monitor cell admittance MAdm is changing toward and away from the target value. The threshold value K1 may, however, have the same hysteresis as that in FIG. 9.

In the example of FIG. 11, at time t21, the admittance deviation Δ Adm is smaller than the threshold value K1, but the monitor cell admittance MAdm is changing away from the target value at the greater admittance change rate XAdm (>K2). The P and I gains are changed to values greater than initially-selected constant values. In the drawing, the admittance change rate XAdm is expressed as an inclination of the monitor cell admittance MAdm. The heater 152 is placed under the PI control using the greater P and I gains. Specifically, the admittance change rate XAdm is, as described above, greater. It is, thus, possible that the monitor cell admittance MAdm will leave away from the target value greatly. To avoid this, the P and I gains are set to the greater values. This causes the admittance change rate XAdm to decrease, however, the admittance deviation Δ Adm exceeds the threshold value K1. The PI control, thus, continues to be performed using the greater P and I gains.

At time t22, the admittance deviation Δ Adm drops below the threshold value K1. When, at time t22, monitor cell admittance MAdm is approaching the target value at the admittance change rate XAdm smaller than the threshold value K3, the PI control continues to be performed without changing the P and I gains. However, when the admittance change rate XAdm is greater than the threshold value K3, the P and I gains are, as illustrated in the drawing, returned to the initially-selected constant gains. Specifically, when the admittance change rate XAmd is great, it means that the monitor cell admittance MAdm will reach the target value in a short time. Therefore, in such an event, the P and I gains are returned to the initially-selected constant gains in order to enhance the heater controllability. In the example of FIG. 11, between times t21 and t22, the PI control is performed using the greater P and I gains.

In the example of FIG. 12, at time t31, the admittance deviation Δ Adm is smaller than the threshold value K1, but the monitor cell admittance MAdm is changing away from the target value at the greater admittance change rate XAdm (>K2). The P and I gains are changed to the values greater than initially-selected constant values. The heater 152 is placed under the PI control using the greater P and I gains. This causes the admittance change rate XAdm to decrease. Afterwards, when the monitor cell admittance MAdm approaches the target value and has dropped below the threshold value K1 at time t32, the P and I gains are returned to the initially-selected constant values. Specifically, between the times t31 and t32, the temperature of the heater 152 is regulated by the PI control using the greater P and I gains.

As apparent from the above discussion, the gas concentration measuring device of this embodiment works to ensure the stability of controlling the temperature of the gas sensor 100 regardless of the disturbance and achieves the high accuracy of measurement of the concentration of NOx.

Note that the PI control for the heater 152 in each of the first and second embodiments may alternatively be performed using only one of the P and I gains.

The gas concentration measuring device in each of the above first and second embodiments may be modified as described below.

The P and I gains may alternatively be returned to the initially-selected values a given period of time after they are set to the greater values when the admittance deviation Δ Adm exceeds a given threshold value or the admittance change rate XAdm exceeds a given threshold value. The period of time may be constant or changed as a function of the admittance change rate XAdm.

Usually, the temperature of exhaust gas of the engine changes with a change in operating condition of the engine, which will be a disturbance imposed on the control of temperature of the body of the gas sensor 100. A change in the temperature of the gas sensor 100 may, therefore, be calculated as a function of the operating condition of the engine and used to change the P and I gains to smaller or greater values. Specifically, the monitor cell admittance MAdm indicative of the temperature of the gas sensor 100 is calculated as a function of a parameter indicative of an engine load (e.g., the negative pressure in an intake pipe of the engine or the position of an accelerator pedal) and used to change the P and I gains.

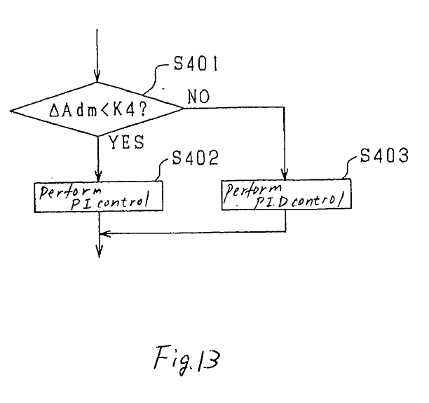

The PI control may be switched to the PID control as needed. Referring to the flowchart of FIG. 13, it is determined in step 401 whether the admittance deviation Δ Adm is smaller than a given threshold value K4 or not. If a YES answer is obtained, then the routine proceeds to step 402 wherein the PI control is performed in the same manner as described above. Alternatively, if a NO answer is obtained, then the routine proceeds to step 403 wherein the proportional-plus-integral-plus-derivative control (PID control) is performed. The operation in FIG. 13 may be performed in combination with one of those in FIG. 7 and 10, thereby controlling the amount of electric power to the heater 152 to minimize a change in the temperature of the gas sensor 100.

The gas concentration measuring device in each of the first and second embodiments may use a multi-cell type gas sensor having four or more cells. For instance, a two-pump cell gas sensor or a multi-gas sensor designed to measure additional concentrations of HC and/or CO may be employed. The typical multi-gas sensor includes the pump cell working to pump the oxygen contained in gas out of the sensor and the sensor cell working to decompose HC or CO contained in the gas after having passed the pump cell to produce a signal indicative of the concentration of HC or CO. Further, the gas concentration measuring device may use any of the above types of gas sensors designed to measure the concentration of gases other than automotive exhaust emissions.

The gas concentration measuring device may also be used with an air/fuel (A/F) ratio sensor which is equipped a single or two cells and designed to measure the concentration of O₂ contained in exhaust emissions of the automotive engine to determine an air-fuel ratio of a mixture supplied to the engine. The above types of gas sensors may be constructed to have a cup-shaped sensor element.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

1. A heater controller working to control an operation of a heater installed in a gas sensor equipped with a solid electrolyte body for heating the gas sensor up to a desired activation temperature, comprising:
a temperature determining circuit working to determine a temperature of the gas sensor; and
a heater power controlling circuit working to control a supply of electric power to the heater under feedback control, said heater power controlling circuit determining a feedback gain used in the feedback control as a function of a deviation of the temperature of the gas sensor as determined by said temperature determining circuit from a target value, said heater power controlling circuit changing the feedback gain based on a condition in which the temperature of the gas sensor is changing from the target value.

2. A heater controller as set forth in claim 1, wherein said heater power controlling circuit increases the feedback gain when the deviation of the temperature of the gas sensor from the target value is greater than a given threshold value.

3. A heater controller as set forth in claim 1, wherein said heater power controlling circuit changes the feedback gain when the temperature of the gas sensor is changing away from the target value, and the deviation of the temperature of the gas sensor from the target value exceeds a first threshold value and when the temperature of the gas sensor is changing toward the target value, and the deviation of the temperature of the gas sensor from the target value drops below a second threshold value smaller than the first threshold value.

4. A heater controller as set forth in claim 1, wherein said heater power controlling circuit increases the feedback gain continuously with an increase in the deviation of the temperature of the gas sensor from the target value.

5. A heater controller as set forth in claim 1, wherein said heater power controlling circuit increases the feedback gain when the temperature of the gas sensor is changing away from the target value, and a rate of change in the temperature of the gas sensor is greater than a given threshold value.

6. A heater controller as set forth in claim 1, wherein said heater power controlling circuit increases the feedback gain when the temperature of the gas sensor is approaching the target value, and a rate of change in the temperature of the gas sensor is smaller than a given threshold value.

7. A heater controller as set forth in claim 1, wherein the gas sensor is installed in an exhaust system of an internal combustion engine to measure an exhaust gas emitted from the engine, and wherein said heater power controlling circuit works to calculate a change in the temperature of the gas sensor as a function of an operating condition of the engine and change the feedback gain based on the calculated change in the temperature of the gas sensor.

8. A heater controller as set forth in claim 1, wherein the feedback gain is one of a proportional gain and an integral gain determined by the deviation of the temperature of the gas sensor from the target.

9. A heater controller as set forth in claim 8, wherein said heater power control circuit further uses a derivative gain in the feedback control to control the supply of electric power to the heater when the deviation of the temperature of the gas sensor from the target value is greater than a given threshold value.

10. A heater controller as set forth in claim 1, wherein the gas sensor includes a first cell, a second cell, and a gas chamber, the first cell being formed by a pair of electrodes affixed to the solid electrolyte body, the second cell being formed by a pair of electrodes affixed to the solid electrolyte body, upon application of voltage across the electrodes, the first cell working to adjust an amount of oxygen contained in a gas entering the gas chamber to a given lower level, the second cell working to measure a concentration of a specified component of the gas after having passed the first cell.

11. A heater controller working to control an operation of a heater installed in a gas sensor equipped with a solid electrolyte body for heating the gas sensor up to a desired activation temperature, comprising:
a temperature determining circuit working to determine a temperature of the gas sensor; and
a heater power controlling circuit working to control a supply of electric power to the heater under feedback control, said heater power controlling circuit determining a feedback gain used in the feedback control as a function of a deviation of the temperature of the gas sensor as determined by said temperature determining circuit from a target value, said heater power controlling circuit setting the feedback gain to a constant value when the temperature of the gas sensor lies within a target range defined across the target value, while said heater power controlling circuit sets the feedback gain to a value greater than the constant value when the temperature of the gas sensor lies out of the target range or when the temperature of the gas sensor is changing at a rate which is expected to cause the temperature of the gas sensor to move out of the target range.

12. A heater controller as set forth in claim 11, wherein said heater power controlling circuit increases the feedback gain continuously as the temperature of the gas sensor changes away from the target range.

13. A heater controller as set forth in claim 11, wherein said heater power controlling circuit returns the feedback gain to the constant value when the temperature of the gas sensor is changing toward the target range again after the temperature of the gas sensor has fallen in the target range.

14. A heater controller as set forth in claim 11, wherein the feedback gain is one of a proportional gain and an integral gain determined by the deviation of the temperature of the gas sensor from the target.

15. A heater controller as set forth in claim 14, wherein said heater power control circuit further uses a derivative gain in the feedback control to control the supply of electric power to the heater when the deviation of the temperature of the gas sensor from the target value is greater than a given threshold value.

16. A heater controller as set forth in claim 11, wherein the gas sensor includes a first cell, a second cell, and a gas chamber, the first cell being formed by a pair of electrodes affixed to the solid electrolyte body, the second cell being formed by a pair of electrodes affixed to the solid electrolyte body, upon application of voltage across the electrodes, the first cell working to adjust an amount of oxygen contained in a gas entering the gas chamber to a given lower level, the second cell working to measure a concentration of a specified component of the gas after having passed the first cell.

17. A heater controller working to control an operation of a heater installed in a gas sensor equipped with a solid electrolyte body for heating the gas sensor up to a desired activation temperature, comprising:
a temperature determining circuit working to determine a temperature of the gas sensor; and
a heater power controlling circuit working to control a supply of electric power to the heater under feedback control, said heater power controlling circuit determining at least one of a proportional gain and an integral gain used in the feedback control as a function of a deviation of the temperature of the gas sensor as determined by said temperature determining circuit from a target value, said heater power controlling circuit further using a derivative gain in the feedback control to control the supply of electric power to the heater when the deviation of the temperature of the gas sensor from the target value is greater than a given threshold value.

18. A heater controller as set forth in claim 17, wherein the gas sensor includes a first cell, a second cell, and a gas chamber, the first cell being formed by a pair of electrodes affixed to the solid electrolyte body, the second cell being formed by a pair of electrodes affixed to the solid electrolyte body, upon application of voltage across the electrodes, the first cell working to adjust an amount of oxygen contained in a gas entering the gas chamber to a given lower level, the second cell working to measure a concentration of a specified component of the gas after having passed the first cell.
